(19) United States
(12) Patent Application Publication
(10) Pub. No.: US 2012/0152069 A1
(43) Pub. Date: Jun. 21, 2012

(54) CNC MACHINES, ADJUSTABLE TOOLS FOR CNC MACHINES, AND METHODS of OPERATING AN ADJUSTABLE TOOL ON A CNC MACHINE

(75) Inventors: Gregory Hyatt, South Barrington, IL (US); Abhijit Sahasrabudhe, Wheeling, IL (US)

(73) Assignee: Mori Seiki Co., Ltd., Hoffman Estates, IL (US)

(21) Appl. No.: 13/325,257

(22) Filed: Dec. 14, 2011

Related U.S. Application Data
(60) Provisional application No. 61/507,933, filed on Jul. 14, 2011.
(60) Provisional application No. 61/423,430, filed on Dec. 15, 2010.

(51) Int. Cl. B23B 7/12; B23B 3/22; B23B 1/00; B23B 3/06

(52) U.S. Cl. 82/1.11; 82/123; 82/121; 82/120

(57) ABSTRACT

Computer numerically controlled (CNC) machines, adjustable material-working tools, and methods of operating an adjustable tool with a CNC machine are presented herein. An adjustable tool for a material-working machine is disclosed. The adjustable tool includes an elongated housing, and one or more cutting inserts at least partially disposed within the housing. Each cutting insert is selectively transversely repositionable with respect to the housing. A wedge is selectively longitudinally repositionable with respect to the housing. The wedge mates with the cutting insert(s) such that longitudinal movement of the wedge effectuates transverse movement of the cutting insert(s). A control arm is movably mounted to the housing. The control arm is configured to mechanically couple the wedge to a prime mover of the material-working machine such that motive force is transferred from the prime mover through the control arm to the wedge for the selective repositioning thereof.

### CROSS-REFERENCE AND CLAIM OF PRIORITY TO RELATED APPLICATION

This application claims the benefit of and priority to U.S. Provisional Patent Application No. 61/423,430, which was filed on Dec. 15, 2010, and U.S. Provisional Patent Application No. 61/507,933, which was filed on Jul. 14, 2011, both of which are incorporated herein by reference in their respective entireties.

### TECHNICAL FIELD

The present disclosure relates generally to material-working machines and tools, and the operation thereof. More particularly, the present disclosure relates to computer numerically controlled (CNC) machines, adjustable tools for CNC machines, as well as methods of operating an adjustable tool on a CNC machine.

### BACKGROUND

Material-working apparatuses, such as saws, lathes, boring machines, milling machines, and drill presses, use a sharp cutting tool to remove material from a workpiece. Historically, material-working apparatuses have been manually controlled via handwheels, levers, and the like. The modern computer numerically controlled (CNC) machine, in contrast, automates the machining of workpieces using programmed commands. In contemporary CNC systems, the machining process is highly computerized, often using computer-aided design (CAD) and computer-aided manufacturing (CAM) programs to design the component and generate the necessary manufacturing steps for fabricating the component. These programs cooperate to produce an electronic-command file that can be interpreted by a computer to extract the commands needed to operate a particular machine or machining tool, and then load the commands into the CNC machine for production.

A typical CNC machine is controlled by a computer program, sometimes referred to as a “part program,” which utilizes the electronic-command file and serially instructs the machine to perform a series of discrete operations in a predetermined sequence. These instructions can include moving one or more machining parts along a programmed path determined by the part program. Each individual instruction is termed a “block,” which may constitute a command for each or a combination of controllable axes. For instance, a block may instruct a boring bar to move rectilinearly a specified distance at a given velocity along the Y-axis of a Cartesian coordinate system. The blocks, once programmed into the computer, are generally set in a sequential order.

Many CNC machines are commercially available. For instance, Mori Seiki USA, Inc., markets a number of different CNC machines, including the NT-Series integrated mill turn center, the ZT-Series multi-tasking turning center, the NV-Series and NH-Series vertical and horizontal machining centers, the NM-Series multi-axis machining centers, and the NL-series lathes. In these and other CNC machines, generally one or more cutting tools are brought into contact with a workpiece under a level of computer control to cause removal of material from the workpiece. Various operations are contemplated, these including milling operations, turning operations, broaching operations and many other conventional such operations.

In high volume and high precision operations, it is often necessary to frequently change tools; for this reason, many CNC machines are provided with associated components that enable tools to be changed quickly and readily. To this end, many CNC machines are equipped with tool changing facilities, such as turrets and automatic tool changers. Some CNC machines are designed with multiple tool turrets, each of which is rotatable to present plural facets to a working position. When a facet is in the working position, a tool mounted thereon may be brought proximal to a workpiece and caused to engage the workpiece for material removal. In many cases, the tool can be driven by a motor when in the working position. In other embodiments, stationary tools are placed on facets of the turret to be used, for example, in various boring or turning operations. Some approaches to increasing the number of tools available in a CNC machine are described in U.S. Pat. No. 6,536,317 B1, to Tsunehiko Yamazaki et al., U.S. Patent Application Publication No. 2006/10075858 A1, to Gregory Hyatt et al., both of which are incorporated herein by reference in their respective entireties. Additional information on CNC Machines, CNC operation, CNC tools, and the like can be found in U.S. Patent Application Publication Nos. 2008/0060491 A1, filed on Sep. 11, 2007, 2008/0219781 A1, filed on Feb. 29, 2008, 2008/0220697 A1, filed on Feb. 29, 2008, 2009/0095126 A1, filed on Oct. 10, 2008, 2010/0130106, filed on Mar. 3, 2008, and U.S. Pat. No. 7,797,074, issued on Sep. 14, 2010, all of which are incorporated herein by reference in their respective entireties.

Some CNC machines are designed to enlarge or contour a pre-fabricated hole in a work-piece by means of a single-point boring tool. Boring tools, generally referred to in the art as “boring bars,” are used by such machines to accurately shape and/or size the bore hole. Most boring bars typically consist of a cutting point (or “insert”) that is rigidly fixed to a solid cutter body. The cutter body, in turn, is operatively gripped in a holder that is automated by a machine spindle. Historically, the cutting point has a single, fixed radius relative to the axis of rotation and, thus, can bore only a single-size hole. Due to wear or slippage, the cutting point of a fixed-radius boring bar may generate an inaccurate bore.

Recently, adjustable boring tools have been designed in which the cutting point can be adjusted radially inward or outward to change the effective cutting radius relative to the spindle axis. These adjustable boring tools are generally limited to provide adjustment to offset use and wear. One known design consists of a threaded dial mechanism that is located between the insert and cutter body, and shifts the cutting point in or out in a continuous manner. A threaded clamp must be released and then retightened to make the adjustment.

Another known adjustable boring bar assembly provides a cutting radius that can be altered by predetermined increments by releasing and turning the bar within a sleeve of a hydraulic holder. The holder sleeve is eccentrically located relative to the spindle axis so that turning of the bar changes the working radius of the cutting point. Slots on the holder, which are arrayed about the sleeve, are located at discrete angular positions. A pin on the boring bar disengages from one slot and re seats in another when the bar is released, turned, and reinserted.

A need still remains for adjustable boring tools that can accurately shape and size holes of variable diameters of workpieces spinning at high rates of speed, at the same time maintaining tight manufacturing tolerances, reducing machining complexity, and shortening the process time of carrying out the machining operations.

### SUMMARY

Aspects of the present disclosure are directed to machining outer and/or inner diameters of a workpiece using a CNC machine. Further aspects are directed to boring-type machining processes for removing material from an enclosed cavity within the workpiece. Yet further aspects are directed to adjustable (rotating or non-rotating) boring bars used to machine the inner cavities of a workpiece. In addition to boring, the adjustable tools can also offer the flexibility of adjusting the tool to compensate for wear and machining complex shapes on the inner and/or outer diameter of workpieces.

Some objectives of one or more of the disclosed embodiments may include, in any combination, providing methods for: mounting an adjustable (rotating or non-rotating) tool on the face of a spindle head of a mill turn and/or a tail stock of a lathe; automatically changing the tool; mounting an adjustable tool on the side of a spindle head of a mill turn machine; actuating the adjustable tool by means of a servo-controlled motor mounted inside a spindle; actuating an adjustable tool by rotating the spindle or tail stock, e.g., clockwise or counter-clockwise, without rotating the tool; actuating an adjustable tool by means of other CNC controllable axis, such as rotational (clockwise or counter-clockwise) and transverse controllable axis for sub or main spindle, and rotational (clockwise or counter-clockwise) and transverse controllable axis of a turret/tool post or a tool located on the turret; actuating an adjustable tool by means of other CNC controllable axis, such as rotational (clockwise or counter-clockwise) or transverse controllable axis for sub or main spindle, and rotational (clockwise or counter-clockwise) or transverse controllable axis of a turret/tool post or a tool located on the turret; actuating an adjustable tool mounted on a turret/tool post by means of other CNC controllable axis, such as tail stock, additional turret/tool post, main spindle or sub-spindle; and, for tool wear compensation.

According to some aspects of the present disclosure, an adjustable tool is presented for a material-working machine operable to remove material from a workpiece. The adjustable tool includes an elongated housing, and one or more cutting inserts that are at least partially disposed within the housing. Each cutting insert is selectively transversely repositionable with respect to the housing. A wedge is selectively longitudinally repositionable with respect to the housing. The wedge mates with the cutting insert(s), and is configured such that longitudinal movement of the wedge effectuates transverse movement of the cutting insert(s). A control arm is movably mounted to the housing. The control arm is connected to the wedge and configured to mechanically couple the wedge to a prime mover of the material-working machine such that motive force is transferred from the prime mover, through the control arm, and to the wedge for the selective repositioning thereof

According to other aspects of the present disclosure, a computer numerically controlled (CNC) machine is disclosed. The CNC machine includes a workpiece holder, a repositionable spindle, a prime mover, and an adjustable tool for removing material from a workpiece. The adjustable tool includes an elongated housing, and one or more cutting inserts at least partially disposed in the housing. Each cutting insert is selectively radially repositionable with respect to the housing. A wedge is selectively longitudinally repositionable within the housing. The wedge mates with the cutting insert(s), and is configured such that longitudinal movement of the wedge effectuates radial movement of the cutting insert(s). A control arm is movably mounted to the housing. The control arm is attached to the wedge and configured to mechanically couple the wedge to the prime mover such that motive force generated by the prime mover is transferred by the control arm to the wedge for the selective repositioning thereof.

According to other aspects of the present disclosure, a method of operating an adjustable tool with a computer numerically controlled (CNC) machine having at least one prime mover is featured. The method includes: attaching the adjustable tool to the CNC machine, the adjustable tool having at least one cutting insert selectively transversely repositionable with respect to a housing, a wedge mating with the at least one cutting insert and configured such that movement of the wedge effectuates transverse movement of the at least one cutting insert, and a control arm movably mounted to the housing and attached to the wedge; mechanically coupling the wedge to the at least one prime mover via the control arm; engaging the at least one cutting insert with a workpiece; and transversely repositioning the at least one cutting insert via the control arm and the wedge through operation of the at least one prime mover.

The above summary is not intended to represent each embodiment or every aspect of the present invention. Rather, the foregoing summary merely provides an exemplification of some of the novel aspects and features set forth herein. The above features and advantages, and other features and advantages of the present disclosure, will be readily apparent from the following detailed description of the exemplary embodiments and best modes for carrying out the present disclosure when taken in connection with the accompanying drawings and appended claims.

### BRIEF DESCRIPTION OF THE DRAWINGS

FIG. 1 is a front-view illustration of an exemplary computer numerically controlled (CNC) machine in accordance with aspects of the present disclosure, shown with safety doors in a closed orientation.

FIG. 2 is a front-view illustration of the exemplary CNC machine of FIG. 1, shown with the safety doors in an open orientation.

FIG. 3 is a perspective-view illustration of certain interior components of the exemplary CNC machine of FIG. 1, depicting a machining spindle, a first chuck, a second chuck, and a turret.

FIG. 4 is an enlarged perspective-view illustration of a portion of the interior components shown in FIG. 3, illustrating horizontally and vertically disposed rails via which the machining spindle may be repositioned.

FIG. 5 is a side-view illustration of the first chuck, machining spindle, and turret shown in FIG. 3.

FIG. 6 is a side-view illustration of the first chuck, machining spindle, and turret shown in FIG. 3, showing the machining spindle translate along the Y-axis.

FIG. 7 is a front-view illustration of the spindle and the first and second chucks of the exemplary CNC machine shown in FIG. 1, depicting a path of rotational movement of the spindle.

FIG. 8 is an enlarged perspective-view illustration of the second chuck illustrated in FIG. 3.

FIG. 9 is a partially cut away and partially exploded perspective-view illustration of the first chuck and turret illustrated in FIG. 2, depicting movement of the turret and turret stock along the Z-axis.

FIG. 10 is a perspective-view illustration of an exemplary adjustable boring tool in accordance with aspects of the present disclosure, shown with two opposing cutting inserts in radially retracted positions.

FIG. 11 is a perspective-view illustration of the exemplary adjustable boring tool of FIG. 10, shown with the two opposing cutting inserts in radially extended positions.

FIG. 11A is a partially exploded perspective-view illustration of the wedge and a single cutting insert from the exemplary adjustable boring tool of FIGS. 10 and 11.

FIG. 12 is a perspective-view illustration of another exemplary adjustable boring tool in accordance with aspects of the present disclosure.

FIGS. 13-15 are schematic side-view illustrations of an exemplary adjustable boring tool in accordance with aspects of the present disclosure, sequentially depicting the actuation and operation of the adjustable boring tool via a b-axis spindle.

FIG. 15A is an enlarged schematic side-view illustration depicting the adjustable inserts being selectively repositioned through the operation of the b-axis spindle servo motor.

FIGS. 16-18 are schematic side-view illustrations of an exemplary adjustable boring tool in accordance with aspects of the present disclosure, sequentially depicting the actuation and operation of the adjustable boring tool via a sub-spindle.

FIGS. 19-20 are schematic side-view illustrations of an exemplary adjustable boring tool in accordance with aspects of the present disclosure, sequentially depicting the actuation and operation of the adjustable boring tool via a turret.

While the present disclosure is susceptible to various modifications and alternative forms, specific embodiments have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of the disclosure as defined by the appended claims.

### DETAILED DESCRIPTION

This disclosure is susceptible of embodiment in many different forms. There are shown in the drawings and will herein be described in detail representative embodiments of the disclosure with the understanding that the present disclosure is to be considered as an exemplification of the principles of the disclosure and is not intended to limit the broad aspect of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, the singular includes the plural and vice versa (unless specifically disclaimed); the words “and” and “or” shall be both conjunctive and disjunctive (unless specifically disclaimed); the word “all” means “any and all”; the word “any” means “any and all”; and the word “including” means “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, as some non-limiting examples.

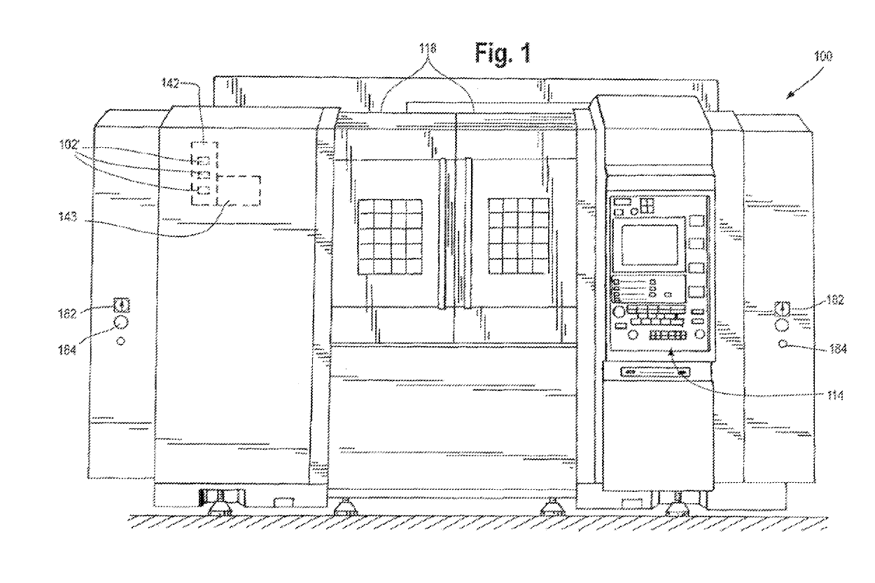

Referring now to the drawings, wherein like reference numerals refer to like components throughout the several views, FIG. 1 illustrates an exemplary computer numerically controlled (CNC) machine, designated generally as 100, in accordance with aspects of the present disclosure. Many of the disclosed concepts are discussed with reference to boring-type CNC machines and boring-type material-working operations. However, the disclosed concepts are not so limited, and can be applied to other material-working operations using other material-working apparatuses. In addition, it should be understood that the drawings are not necessarily to scale and are provided purely for descriptive purposes; thus, the individual and relative dimensions and orientations presented in the drawings are not to be considered limiting.

Any suitable apparatus may be employed in conjunction with the devices and methods of this disclosure. In some embodiments, the methods are performed using the exemplary CNC machine 100 illustrated generally in FIGS. 1-9. A CNC machine is itself provided in other embodiments of the disclosure. The CNC machine 100 illustrated in FIGS. 1-9 is representative of an NT-series machine, versions of which are available from Mori Seiki USA, Inc., the assignee of the present application. Other suitable computer numerically controlled machines include the NL-series machines with turret (not shown), also available from Mori Seiki USA, Inc. Other machines may be used in conjunction with the aspects of this disclosure, including the NZ, NH, NV, and NMV machines, also available from Mori Seiki USA, Inc.

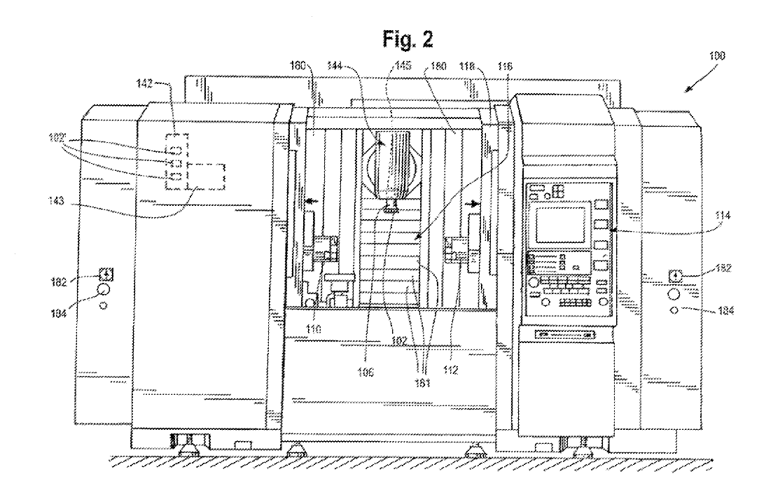

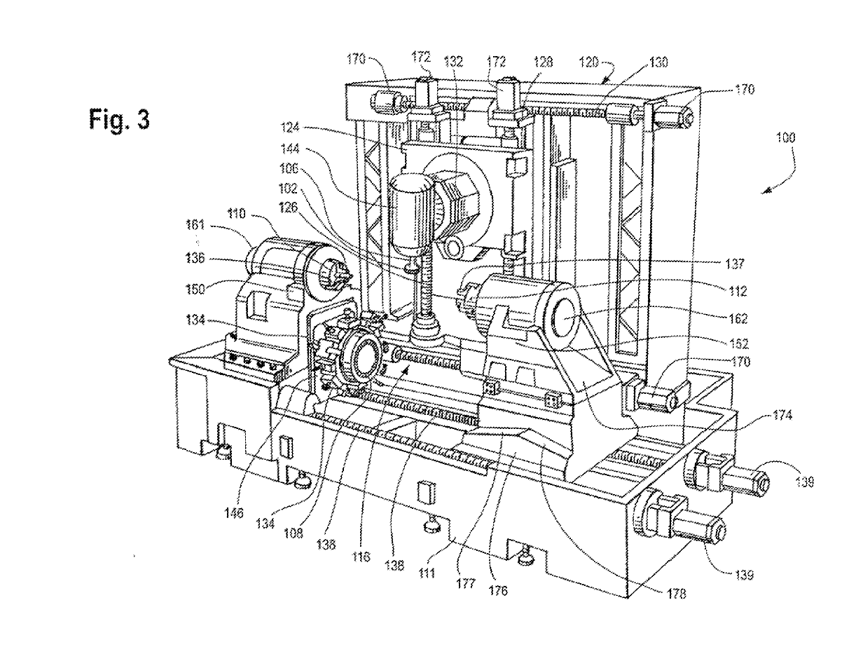

In general, with reference to the NT-series CNC machine 100 illustrated in FIGS. 1-3, one suitable CNC machine 100 has at least a first retainer and a second retainer, each of which may be one of a spindle retainer associated with spindle 144 (also referred to herein as “b-axis spindle”), as seen in FIG. 2, a turret retainer associated with a turret 108, as seen in FIG. 3, or a chuck 110, 112, as seen in FIG. 2. In the embodiment illustrated in the Figures, the CNC machine 100 is provided with a turret 108, a first chuck 110, a second chuck 112, and a spindle 144. The CNC machine 100 also has a computer control system operatively coupled to the first and second retainers for controlling the retainers, as described in more detail below. It is understood that in some embodiments, the CNC machine 100 may not contain all of the above components, while in other embodiments, the CNC machine 100 may contain fewer, additional, or alternative components beyond those designated herein.

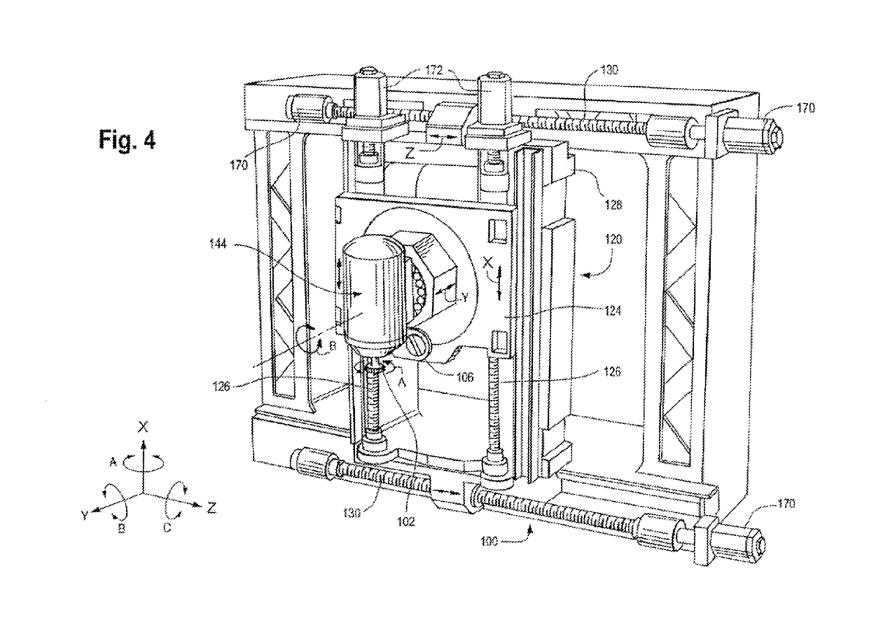

As shown in FIGS. 1 and 2, the CNC machine 100 has a machine chamber, generally indicated at 116, in which various operations generally take place upon a workpiece. Each of the turret 108, the first chuck 110, the second chuck 112, and the spindle 144 may be completely or partially located within the machine chamber 116. In the embodiment shown, two moveable safety doors 118 can be closed, as seen in FIG. 1, to separate the user from the machine chamber 116, for example, to prevent injury to the user or interference in the operation of the CNC machine 100. The safety doors 118 can likewise be opened to permit access to the machine chamber 116, as illustrated in FIG. 2. The function and operation of the CNC machine 100 is described herein with respect to three orthogonally oriented Cartesian axes X, Y, and Z, depicted in FIG. 4 and described in greater detail below. Rotational axes about the X, Y and Z axes are connoted “A,” “B,” and “C” rotational axes, respectively.

The CNC machine 100 can be provided with a computer control system for controlling the various instrumentalities within and the operation of the CNC machine 100. In the illustrated embodiment, the CNC machine 100 is provided with two interlinked computer systems: a first computer system comprising a user interface (shown generally at 114 in FIG. 1) and a second computer system (shown schematically at 115 in FIG. 1) operatively connected to the first computer system 114. The second computer system 115 (also referred to herein as “machine control system”) directly controls the operations of the turret 108, the spindle 144, and the other instrumentalities of the CNC machine 100, while the first computer system 114 (also referred to herein as “user interface system”) allows an operator to control the second computer system 115. Collectively, the machine control system 115 and the user interface system 114, together with the various mechanisms for control of operations in the CNC machine 100, may be considered a single computer control system. In some embodiments, the user operates the user interface system 114 to impart programming to the CNC machine 100; in other embodiments, programs can be loaded or transferred into the CNC machine 100 via external sources. It is contemplated, for instance, that programs may be loaded via a PCMCIA interface (e.g., a PC card), an RS-232 interface (e.g., a computer serial port), a universal serial bus (USB) interface, or a network interface, such as a TCP/IP network interface. Optionally, the CNC machine 100 may be controlled via conventional PLC (programmable logic controller) mechanisms (not illustrated).

As further illustrated in FIGS. 1 and 2, the CNC machine 100 may have a tool magazine 142 and a tool changing device 143. These components cooperate with the spindle 144 to permit the spindle 144 to operate with a variety of cutting tools (shown schematically in FIG. 1 as tools 102′). Generally, a variety of cutting tools may be provided; however, in some embodiments, plural tools of the same type may be provided.

Turning to FIG. 3, the spindle 144 is within the machine chamber 116. In the illustrated embodiment, the spindle 144 is mounted on a carriage assembly 120, which is controlled for translational movement of the spindle 144 along the X- and Z-axes, and on a ram 132, which is controlled for the spindle 144 to be moved in the Y-axis. The ram 132 is equipped with a motor to allow rotation of the spindle 144 in the B-axis, as set forth in more detail hereinbelow. As illustrated, the carriage assembly 120 has a first carriage 124 that rides along two vertically oriented, threaded rails (one of which is designated at 126 in FIG. 3) to cause the first carriage 124 and, thus, the spindle 144 to translate up and down along the X-axis. The carriage assembly 120 also includes a second carriage 128 that rides along two horizontally oriented, threaded rails (one labeled at 130 in FIG. 3) to allow side-to-side movement of the second carriage 128 and, thus, the spindle 144 along the Z-axis. Each carriage 124, 128 engages their respective rails via one or more ball screw devices, whereby rotation of the rails 126, 130 causes translation of the carriage 124, 128 in the X- and Z-direction, respectively. The vertically and horizontally disposed rails 126, 130 can each be equipped with a motor 170 and 172, respectively.

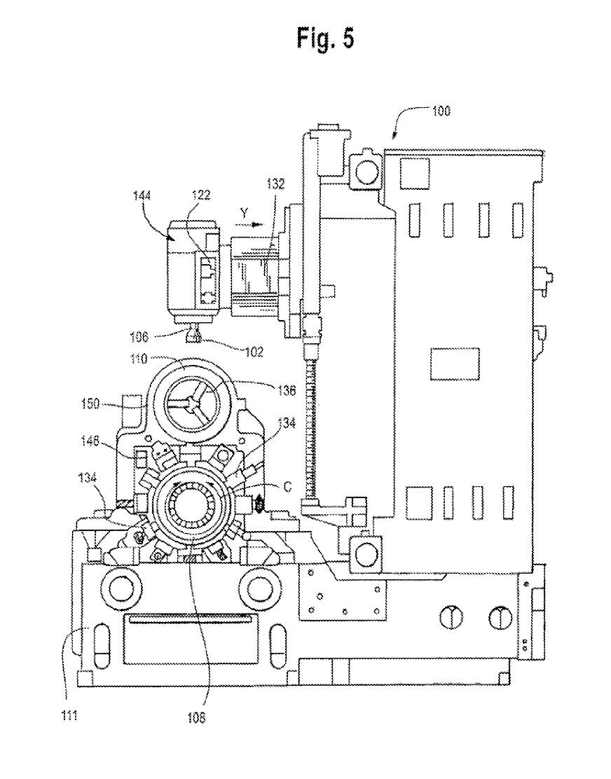

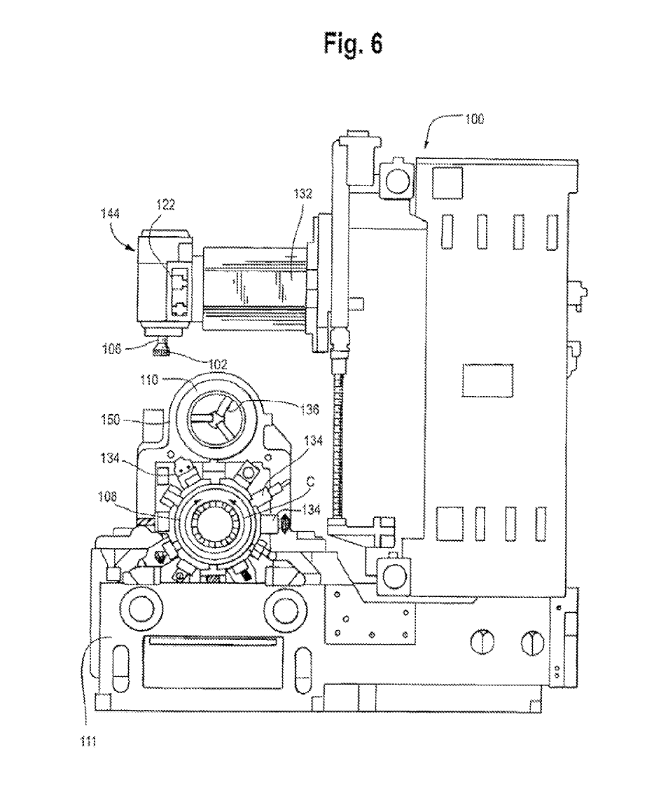

The spindle 144 is operable to engage, hold and move a cutting tool 102 by way of a spindle connection 145 (shown in FIG. 2) and a tool holder 106. The spindle connection 145 is connected to the spindle 144 and is contained within the tool holder 106. The tool holder 106 is connected to the spindle connection 145 and holds the cutting tool 102. Various types of spindle connections are known in the art and can be used with the computer numerically controlled machine 100. Typically, the spindle connection 145 is contained within the spindle 144 for the life of the spindle 144. An access plate 122 for the spindle 144 is shown in FIGS. 5 and 6.

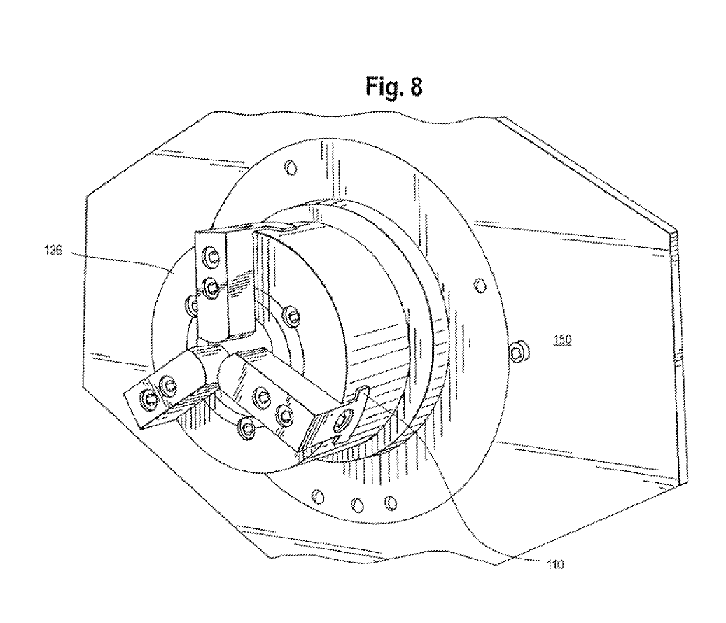

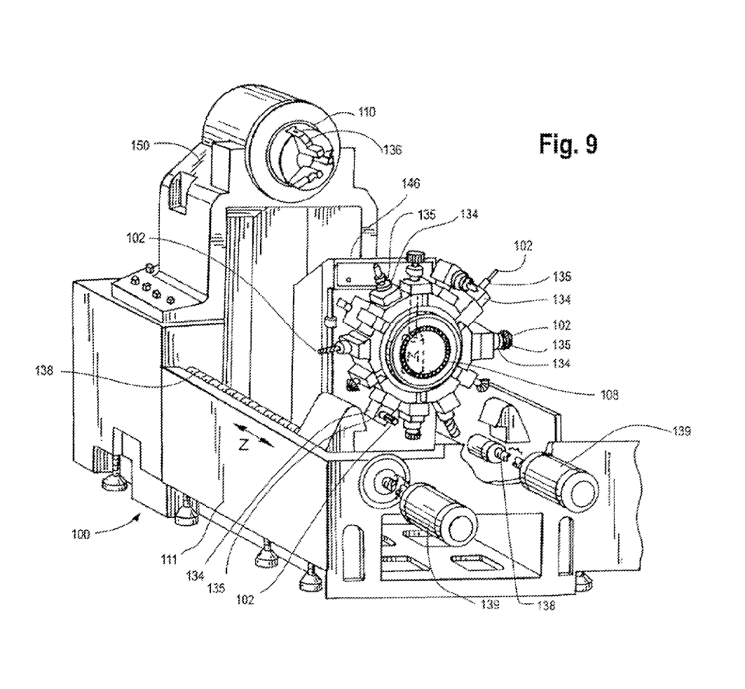

The first chuck 110 is provided with movable jaws 136, which are shown in detail in FIGS. 8 and 9. The first chuck 110 is operatively retained in a stock 150, which is stationary with respect to the base 111 of the CNC machine 100. The second chuck 112 is also provided with movable jaws 137. Unlike the first chuck 110, however, the second chuck 112 is movable with respect to the base 111 of the CNC machine 100. More specifically, the CNC machine 100 is provided with two horizontally oriented, threaded rails 138, each of which has a respective motor 139 for causing translation in the Z-direction of the second stock 152 via a ball screw mechanism as heretofore described. To assist in the removal of swarf (also known as turnings, chips, or filings), the second stock 152 is provided with a sloped distal surface 174 and a side frame 176 with Z-sloped surfaces 177, 178. Hydraulic controls and associated indicators for the chucks 110, 112 may be provided, such as the pressure gauges 182 and control knobs 184 shown in FIGS. 1 and 2. Each stock 150, 152 is provided with a motor (161, 162 respectively) for causing rotation of the chuck 110, 112, respectively.

The turret 108, which is best depicted in FIGS. 5, 6 and 9, is mounted in a turret stock 146 (FIG. 5). The turret stock 146 engages the two horizontally oriented, threaded rails 138 and, thus, may be translated back-and-forth along the Z-axis, for example, via ball-screw devices. The turret 108 is provided with various turret connectors (or “facets”) 134, which are shown in greater detail in FIG. 9. Each turret connector 134 can be connected to a tool holder 135 or other connection means for connecting to a cutting tool, each of which is designated 102 irrespective of type. Since the turret 108 can have a variety of turret connectors 134 and tool holders 135, a variety of different cutting tools 102 can be held and operated by the turret 108. The turret 108 may be rotated in the C-axis to present different ones of the tool holders (and hence, in many embodiments, different tools) to a workpiece.

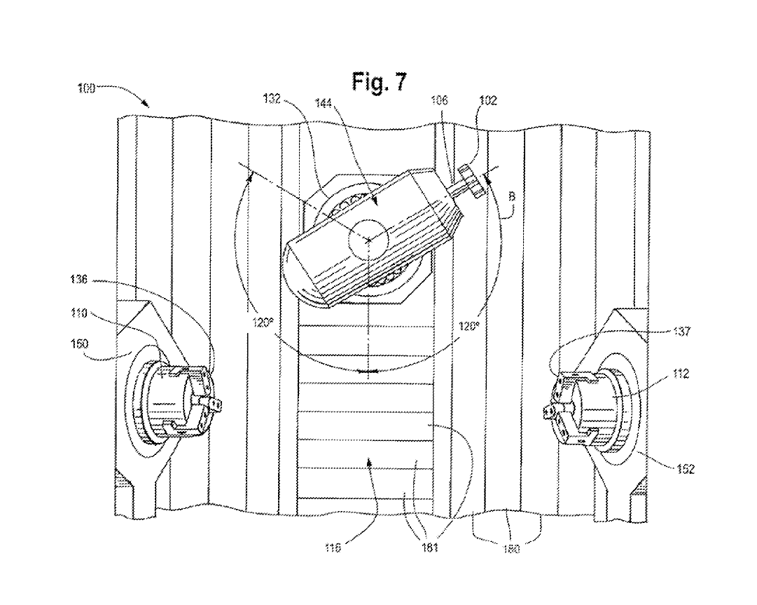

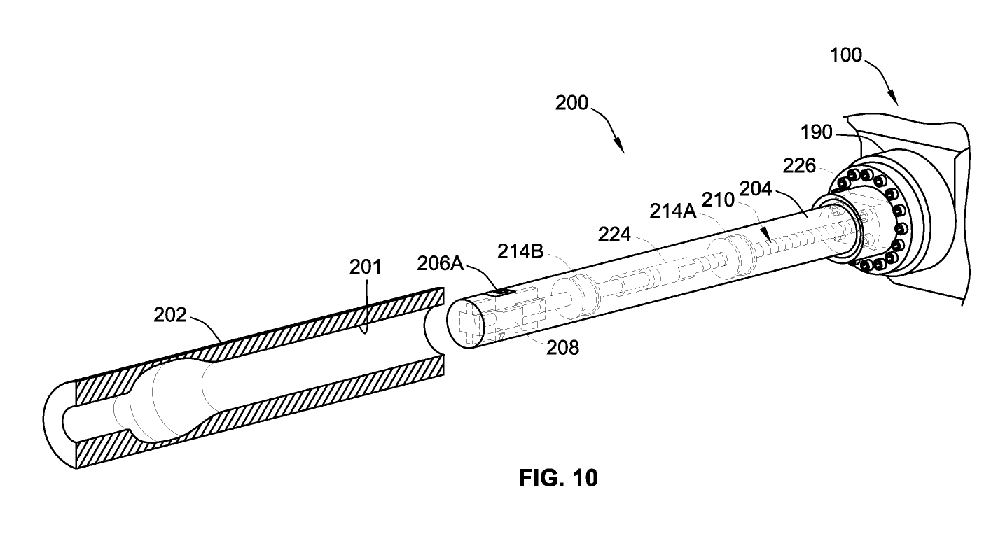

It is thus seen that a wide range of versatile operations may be performed by the CNC machine 100. With reference to tool 102 held in tool holder 106, such tool 102 may be brought to bear against a workpiece (e.g., FIG. 10) held by one or both of the chucks 110, 112. When it is necessary or desirable to change the tool 102, a replacement tool 102 may be retrieved from the tool magazine 142 by means of the tool changing device 143. With reference to FIGS. 4 and 5, the spindle 144 may be translated in the X- and Z-directions, as shown in FIG. 4, and the Y-direction, as shown in FIGS. 5 and 6. Rotation in the B-axis is depicted in FIG. 7, wherein the illustrated embodiment permits rotation within a range of 120° to either side of vertical. Movement in the Y-direction and rotation in the B-axis are powered by motors (not shown) that are located behind the carriage 124. Generally, as seen in FIGS. 2 and 7, the CNC machine 100 is provided with a plurality of vertically disposed leaves 180 and horizontally disposed leaves 181 to define a wall of the chamber 116 and to prevent swarf from exiting the machine chamber 116.

The components of the machine 100 are not limited to the heretofore described components. For example, in some instances the CNC machine 100 may be provided with an additional turret. In other instances, additional chucks and/or spindles may be provided. Generally, the CNC machine 100 is provided with one or more mechanisms for introducing a cooling liquid into the chamber 116.

In the illustrated embodiment, the CNC machine 100 is provided with numerous retainers. By way of non-limiting example, first chuck 110 in combination with jaws 136 forms a retainer, as does chuck 112 in combination with jaws 137. In many instances, these retainers will also be used to hold a workpiece. For instance, the chucks 110, 112 and associated stocks 150, 152 will function in a lathe-like manner as the headstock and optional tailstock for a rotating workpiece. Spindle 144 and spindle connection 145 form another retainer. Similarly, the turret 108 shown in FIG. 9, when equipped with plural turret connectors 134, provides a plurality of retainers.

The CNC machine 100 may use any of a number of different types of cutting tools known in the art or otherwise found to be suitable. For instance, the cutting tool 102 may be a milling tool, a drilling tool, a grinding tool, a blade tool, a broaching tool, a turning tool, or any other type of material-working tool deemed appropriate in connection with a CNC machine 100. As discussed above, the computer numerically controlled machine 100 may be provided with more than one type of cutting tool, and via the mechanisms of the tool changing device 143 and magazine 142, the spindle 144 may be caused to exchange one tool for another. Similarly, the turret 108 may be provided with one or more cutting tools 102, and the operator may switch between cutting tools 102 by causing rotation of the turret 108 to bring a new turret connector 134 into the appropriate position.

Other features of a computer numerically controlled machine include, for instance, an air blower for clearance and removal of chips, various cameras, tool-calibrating devices, probes, probe receivers, and lighting features. The CNC machine 100 illustrated in FIGS. 1-9 is not the only machine of the disclosure, but to the contrary, other embodiments are envisioned.

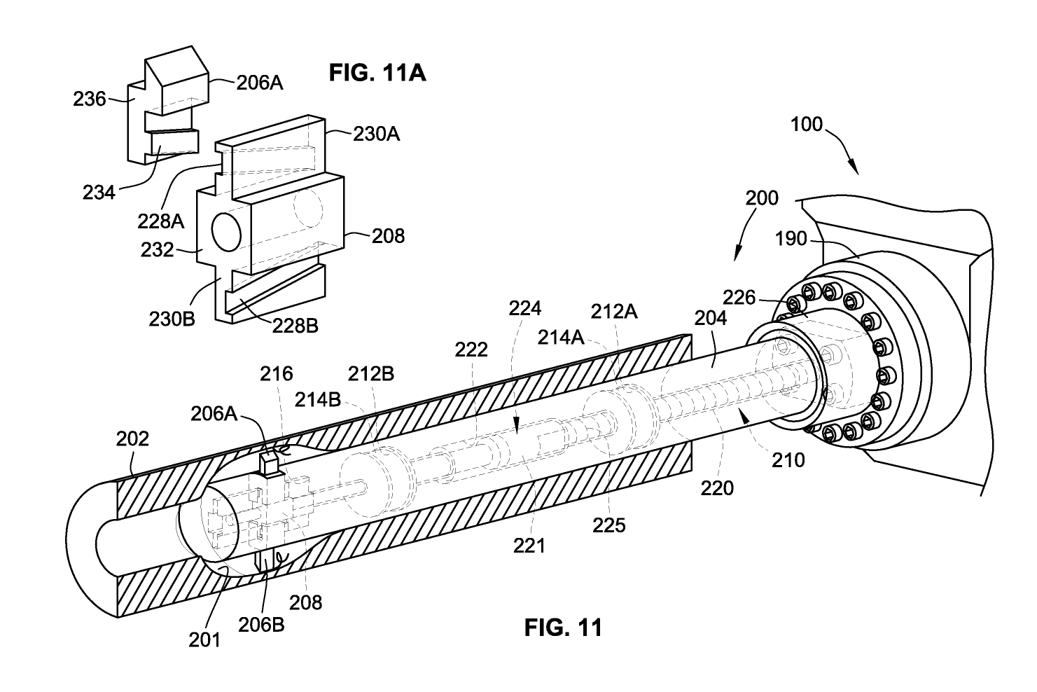

Turning to FIGS. 10 and 11, an exemplary adjustable material-working tool, designated generally as 200, is illustrated in accordance with aspects of the present disclosure. The adjustable tool 200 is operable, in conjunction with a material-working machine, such as CNC machine 100 of FIGS. 1-9, for removing material from a workpiece 202, as described in further detail below. By way of non-limiting example, the adjustable tool 200 illustrated in FIGS. 10 and 11 can act as a multi-point variable boring tool (rotating or non-rotating) intended for machining (e.g., sizing and shaping) the inner diameter of an enclosed cavity 201 within a workpiece 202 through operation of the CNC machine 100. The adjustable tool 200 can offer the flexibility of adjusting the tool's cutting points, for example, to compensate for wear, and the capability for machining complex shapes on the inner diameter of workpieces. As will become more apparent from the following description, the adjustable tool 200 advantageously eliminates the need for additional driving mechanisms (i.e., a supplementary motor dedicated to operating the tool 200) and, thus, eliminates the need for additional electrical and mechanical hardware housed by the tool 200 to accommodate an added driving mechanism.

The adjustable tool 200, as exemplified in FIGS. 10 and 11, includes four primary components: a housing 204, one or more cutting inserts 206A and 206B (FIG. 11), a wedge 208, and a control arm 210. The housing 204 is an elongated, cylindrical body that is fabricated from a resilient material, such as aluminum and ferrous alloys (e.g., iron or steel), and configured to store and protect one or more of the moving parts of the adjustable tool 200. In one embodiment, the length-to-diameter ratio of the adjustable tool 200 is 20:1, but greater or lesser length-to-diameter ratios may be used in accord with the present concepts. Although shown as a right circular cylinder, the housing 204 can take on additional shapes and sizes without departing from the scope and spirit of the present disclosure. By way of non-limiting example, the housing 204 can take on polyhedral shapes, such as rectangular hexahedral or octahedral shapes, as well as any number of cylinders with non-circular cross-sections. A mounting cap 226 at the proximal end of the housing 204 is configured to attach the adjustable tool 200 to the CNC machine 100, which is, in the illustrated example, the cone coupling 190 of a tool change slide.

Defined within the housing 204 are a plurality of longitudinally spaced compartments, each of which operatively stores one or more of the various constituent parts of the tool 200. Two drum-shaped bushing compartments 212A and 212B, each of which retains therein a respective bushing 214A and 214B, are spaced between the longitudinal ends of the housing 204. At the distal end of the housing 204 is a cross-shaped wedge compartment 216, which operatively nests the cutting inserts 206A, 206B and wedge 208. Conversely, at the proximal end of the housing 204 is an elongated control arm compartment 220, which houses a substantial portion of the control arm 210. An elongated ball nut compartment 222 extends between the two bushing compartments 212A, 212B and operatively retains therein a ball nut 224. The number, shape, size, and location of the various compartments can be varied from that shown in FIGS. 10 and 11 depending, for example, on the internal componentry of the adjustable tool 200. Some aspects of the disclosed concepts include guide pads (now shown) along the circumferential perimeter of the housing to provide additional rigidity.

At least one, and in some arrangements two cutting inserts 206A, 206B are disposed, at least partially, inside the housing 204, as seen in FIG. 10. In the illustrated embodiment, the cutting inserts 206A, 206B are generally coplanar to one another, each extending from a respective opposing side of the movable wedge 208 and housing 204. Each cutting insert 206A, 206B can be transversely repositioned with respect to the housing 204. As shown in the drawings, for example, the cutting inserts 206A, 206B can be retracted or otherwise moved radially inwardly to nest inside the housing 204, as seen in FIG. 10, and extracted or otherwise moved radially outwardly to project out from the housing 204 and into engagement with the cavity 201 of the workpiece 202, as seen in FIG. 11.

The wedge 208 can be longitudinally repositioned within the wedge compartment 216 of the housing 204. The wedge 208, which is most readily perceived in FIG. 11A, includes two integrally formed, coplanar engagement arms 230A and 230B, each of which extends generally orthogonally from a respective opposing side of a wedge base 232. The engagement arms 230A, 230B each include an angled slot 228A and 228B, respectively, that extends at an angle with respect to the longitudinal center-axis of the housing 204. Slidably received within each angled slot 228A, 228B is a complementary protrusion 234 that projects inwardly from a leg 236 of a corresponding cutting insert 206A, 206B. Although only one protrusion 234 is visible in FIG. 11A, a similar protrusion projects inwardly from a leg of the second insert 206B. In alternative designs, the angled slots can be defined by the cutting inserts 206A, 206B, while the corresponding protrusions received within the angled slots project from the wedge 208. It is also envisioned that other means of interface between the cutting inserts 206A, 206B and wedge 208 be provided by which movement of the wedge 208 will effectuate movement of the cutting inserts 206A, 206B. These alternative means may include, but are certainly not limited to, a dual-rack-and-pinion system, a gear train, a worm gear-and-wheel system, a cam wheel, a control rod with an integrally formed cam or ramp surface, a fluid coupling, such as a pneumatic hydraulic interface, etc.

When the wedge 208 is moved in a first axial direction (e.g., pushed rectilinearly in a leftward direction in FIGS. 10 and 11), the angled slots 228A, 228B apply a radially inward force to the protrusions 234, whereby the inserts 206A, 206B are pulled inside the housing 204, as seen in FIG. 10. In contrast, the angled slots 228A, 228B apply a radially outward force to the protrusions 234 when the wedge 208 is moved in a second direction opposite the first direction (e.g., pulled rectilinearly in a rightward direction in FIGS. 10 and 11), whereby the inserts 206A, 206B are urged out of the housing 204, as seen in FIG. 11. In other words, longitudinal movement of the wedge 208 effectuates transverse movement of the cutting inserts 206A, 206B. In some embodiments, the wedge compartment 216 acts as a complementary guide slot, which stabilizes the rectilinear motion of the wedge 208, and restricts inadvertent transverse and rotational movement of the wedge 208. Likewise, the slots through which the cutting inserts 206A, 206B project out of the wedge compartment 216 can maintain longitudinal and radial alignment of the cutting inserts 206A, 206B.

The control arm 210 is movably mounted inside the housing 204. In the exemplary embodiment illustrated in FIGS. 10 and 11, the control arm 210 is concentrically aligned with the housing 204, extending from the proximal to the distal end of the housing 204. The control arm 210 is operatively attached at a distal end thereof to the wedge 208; at a proximal end, the control arm 210 interfaces with a prime mover, designated generally as 190 in FIGS. 10 and 11, of the CNC machine 100. In so doing, the control arm 210 mechanically couples the wedge 208 to the prime mover 190 of the CNC machine 100 such that the motive force generated by the prime mover 190 is transferred therefrom, through the control arm 210, to the wedge 208. It is through the interplay of the prime mover 190, control arm 210, and wedge 208 that the inserts 206A, 206B are selectively repositioned. That is, the prime mover 190 creates a translational or rotational force, as described in detail below, which is transmitted to the control arm 210. The control arm 210, in turn, transmits the translational/rotational forces generated by the prime mover 190 to the wedge 208. Depending on the configuration of the control arm 210, the translational/rotational forces are converted to rotational/translational forces, respectively, prior to being transmitted to the wedge 208. The forces transferred by the control arm 210 urge (e.g., push or pull) the wedge 208 axially forward and backward inside the wedge compartment 216, which acts to radially reposition the inserts 206A, 206B, as described above.

The control arm 210 of the exemplary embodiment set forth in FIGS. 10 and 11 is a ball screw assembly 210, which is a mechanical linear actuator that is operable to convert rotational forces generated by the prime mover 190 into linear forces. The ball screw assembly 210 is designed to then transmit these linear forces to the wedge 208 to thereby selectively reposition the wedge 208. The ball screw assembly 210 includes a ball nut 224 with an internally threaded proximal receiving portion, which receives therein a distal end of a threaded shaft 225. The threaded shaft 225 provides a spiral raceway for ball bearings (not visible in the views provided), which travel intermediate complementary threads of the nut 224 and shaft 225. A distal interface portion 223 of the ball nut 224 is rigidly connected to the wedge 208. In contrast to conventional power screws, the ball screw assembly 210 is able to apply and withstand high thrust loads, doing so with minimum internal friction. While reducing friction, the ball screw assembly 210 can operate under preload, which helps to eliminate backlash (“slop”) between input (e.g., rotation) and output (e.g., linear motion).

A proximal end of the threaded shaft 225 is coupled to the prime mover 190 which, in the provided example, is a cone coupling of a tool change slide. The cone coupling, due to its frustoconical receiving surface, can stably secure a relatively long tool. The first bushing 214A is disposed between the threaded shaft 225 and the housing 204, whereas the second bushing 214B is disposed between the interface portion 223 of the ball nut 224. The bushings 214A, 214B provide lateral operative support for the moving segments of the ball screw assembly 210. In operation, a servo motor inside the tool change slide 190 selectively rotates the threaded shaft 225. As the threaded shaft 225 rotates, the ball bearings traverse along the raceway interface between the distal end of the threaded shaft 225 and the internal threading of the proximal receiving portion 221 of the ball nut 224. By restricting rotation of the ball nut 224 along its central axis, continued rotation of the threaded shaft 225 in a first direction (e.g., clockwise) will push or otherwise urge the ball nut 224 and, thus, the wedge 208 to translate rectilinearly in a first direction (e.g., leftward with respect to FIGS. 10 and 11). Contrastingly, reciprocal rotation of the threaded shaft 225 in an opposite, second direction (e.g., counter-clockwise) will cause the ball nut 224 and, thus, the wedge 208 to translate rectilinearly in an opposite, second direction (e.g., rightward with respect to FIGS. 10 and 11). In so doing, the projection and retraction of the cutting inserts 206A, 206B in and out of the housing 204, respectively, can be carefully controlled through operation of the servo motor inside the tool change slide 190.

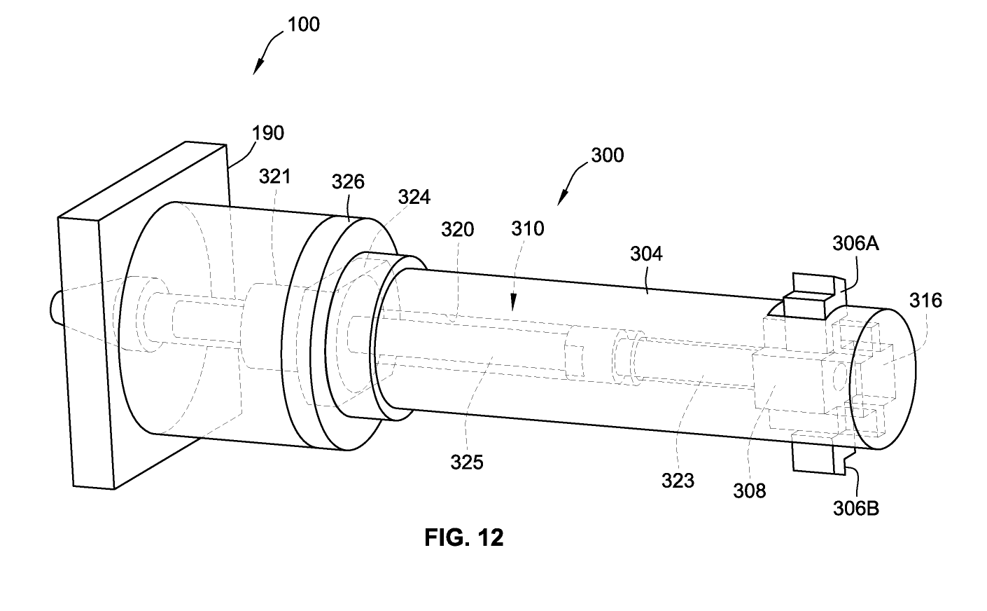

FIG. 12 of the drawings presents another exemplary adjustable boring tool, indicated generally by reference numeral 300, in accordance with aspects of the present disclosure. Similar to the tool 200 of FIGS. 10 and 11, the adjustable boring tool 300 of FIG. 12 is operable, in conjunction with a material-working machine, such as CNC machine 100 of FIGS. 1-9, for removing material from a workpiece. The adjustable tool 300 includes four primary components: a housing 304, a pair of cutting inserts 306A and 306B, a wedge 308, and a control arm 310. The housing 304 is an elongated, cylindrical body that defines therein a plurality of longitudinally spaced compartments. These compartments include, but are certainly not limited to: a cross-shaped wedge compartment 316, which is located at the distal end of the housing 304, that operatively nests the cutting inserts 306A, 306B and wedge 308; an elongated control arm compartment 320, which extends approximately the length of the housing 304 and houses a portion of the control arm 310; and, a ball nut compartment 322 at the proximal end of the housing 304 that operatively retains therein a ball nut 324. A mounting cap 326 at the proximal end of the housing 304 is configured to attach the adjustable tool 300 to a prime mover of the CNC machine 100, the prime mover comprising a cone coupling as shown. The housing 304 of FIG. 12 can be configured and modified in accordance with any of the options set forth above with respect to the housing 204 of FIGS. 10 and 11. Likewise, the cutting inserts 306A, 306B and wedge 308 of FIG. 12 can be designed and modified to function in accordance with any of the characteristic and optional features discussed above with respect to the cutting inserts 206A, 206B and wedge 208 of FIGS. 10 and 11.

In the exemplary embodiment illustrated in FIG. 12, the control arm 310 is concentrically aligned with the housing 304, extending from the proximal to the distal end of the housing 304. The control arm 310 is operatively attached at a distal end thereof to the wedge 308; at a proximal end, the control arm 310 operatively interfaces with the prime mover 190 of the CNC machine 100. In so doing, the control arm 310 mechanically couples the wedge 308 to the prime mover 190 of the CNC machine 100 such that the motive forces generated by the prime mover 190 are transferred therefrom, through the control arm 310, to the wedge 308. It is through the interplay of the prime mover 190, control arm 310, and wedge 308 that the inserts 306A, 306B are selectively repositioned.

Like the control arm 210 of FIGS. 10 and 11, the control arm 310 of FIG. 12 is a ball screw assembly 310 operable to convert rotational forces into linear forces (or vice versa), and transmit the converted forces to the wedge 308. The underlying functionality and basic structure of the ball screw assembly 310 is generally similar to the ball screw assembly 210 of FIGS. 10 and 11, and therefore will not be repeated for brevity purposes. In contradistinction, however, the operation of the ball screw assembly 310 differs from the ball screw assembly 210 of FIGS. 10 and 11. In particular, the ball screw assembly 310 includes a ball nut 324, which receives therethrough a threaded shaft 325. Attached to a distal end of the threaded shaft 325 is an interface portion 323, which is rigidly connected to the wedge 308. A proximal end 321 of the ball nut 324 is coupled to the prime mover 190, which is presented in the drawings as a cone coupling of a tool change slide. In operation, a servo motor inside the tool change slide 190 selectively rotates the ball nut 324. As the ball nut 324 rotates, internal ball bearings (not shown) traverse along the raceway interface between the threaded shaft 325 and internal threading of the ball nut 324. By restricting lateral translation of the ball nut 324 along the central axis of the housing 304, continued rotation of the ball nut 324 in a first direction (e.g., clockwise) will urge the ball screw 325 and, thus, the wedge 308 rectilinearly in a first direction (e.g., rightward with respect to FIG. 12). Contrastingly, reciprocal rotation of the ball nut 324 in an opposite, second direction (e.g., counter-clockwise) will cause the ball screw 325 and, thus, the wedge 308 to translate rectilinearly in an opposite, second direction (e.g., leftward with respect to FIG. 12). In so doing, the projection and retraction of the cutting inserts 306A, 306B in and out of the housing 304, respectively, can be carefully controlled through operation of the servo motor inside the tool change slide 190.

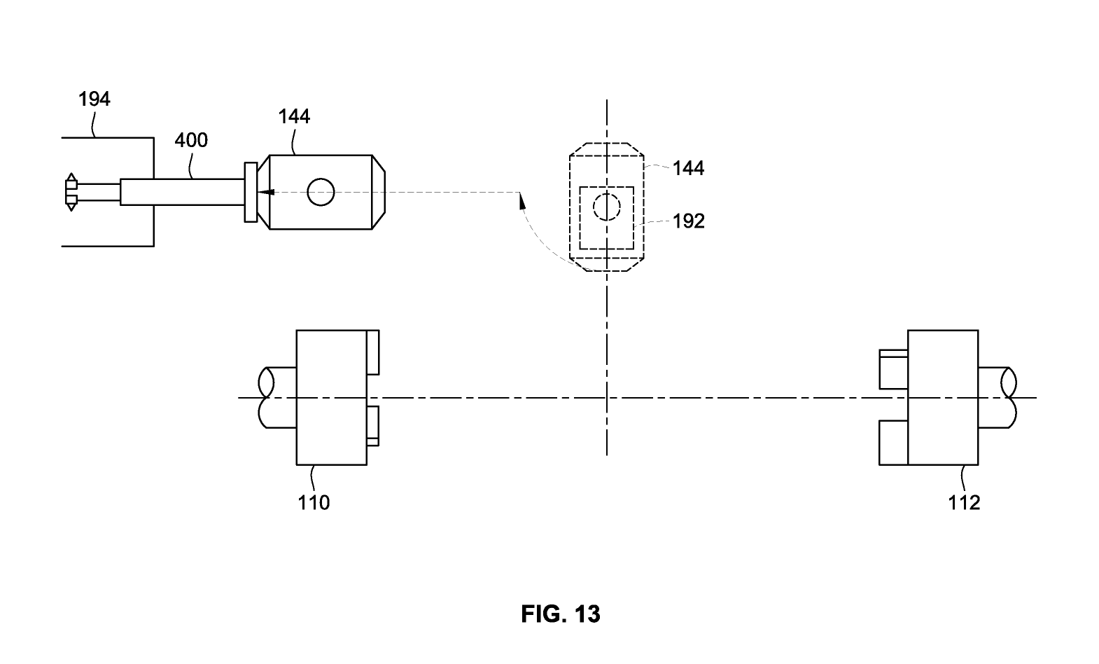

Turning next to FIGS. 13-15, the actuation and operation of an exemplary adjustable boring tool 400 via a movably mounted tool spindle—e.g., “b-axis” spindle 144 of the CNC machine 100, is sequentially illustrated in accordance with aspects of the present disclosure. In this particular representative arrangement, the adjustable boring bar 400 is mounted on the face of the tool spindle 144. The adjustable boring bar 400 is actuated by rotational forces generated by the tool spindle 144, e.g., via an internally housed servo motor 192. While not specifically required for the purposes of this embodiment, the adjustable boring bar 400 can take on the same general configuration as the adjustable tools 200 and 300 presented above.

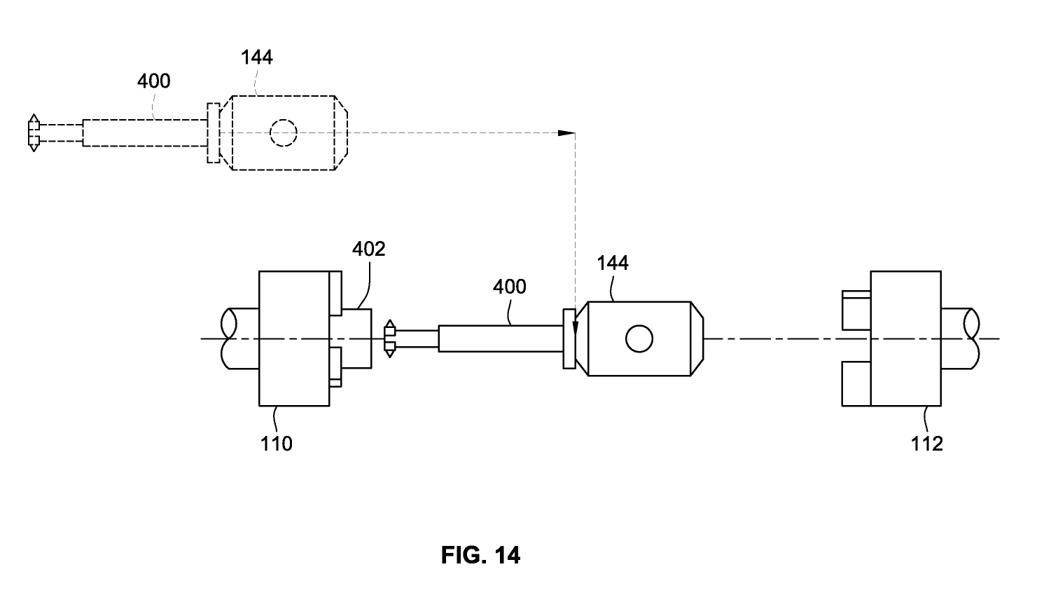

As seen in FIG. 13, the b-axis spindle 144 is repositioned, for example, via carriage assembly 120 and ram 132 of FIG. 3, from a first location and orientation (illustrated at 144 with hidden lines in FIG. 13) to a second location and orientation (illustrated at 144 with solid lines in FIG. 13). Once repositioned, the spindle 144 attaches to, picks up, or otherwise grabs the adjustable boring bar tool 400 from a tool rack 194. Alternatively, the tool 400 can be manually loaded into the spindle 144 or, optionally, permanently attached to the spindle 144. The spindle 144 then transitions from the second location to a third location (illustrated at 144 with solid lines in FIG. 14) to thereby reposition and operatively align the tool 400 with a main spindle, such as first chuck 110 of the CNC machine 100. The first chuck 110 of FIG. 14 is operable to receive, lock to and operatively retain a workpiece 402.

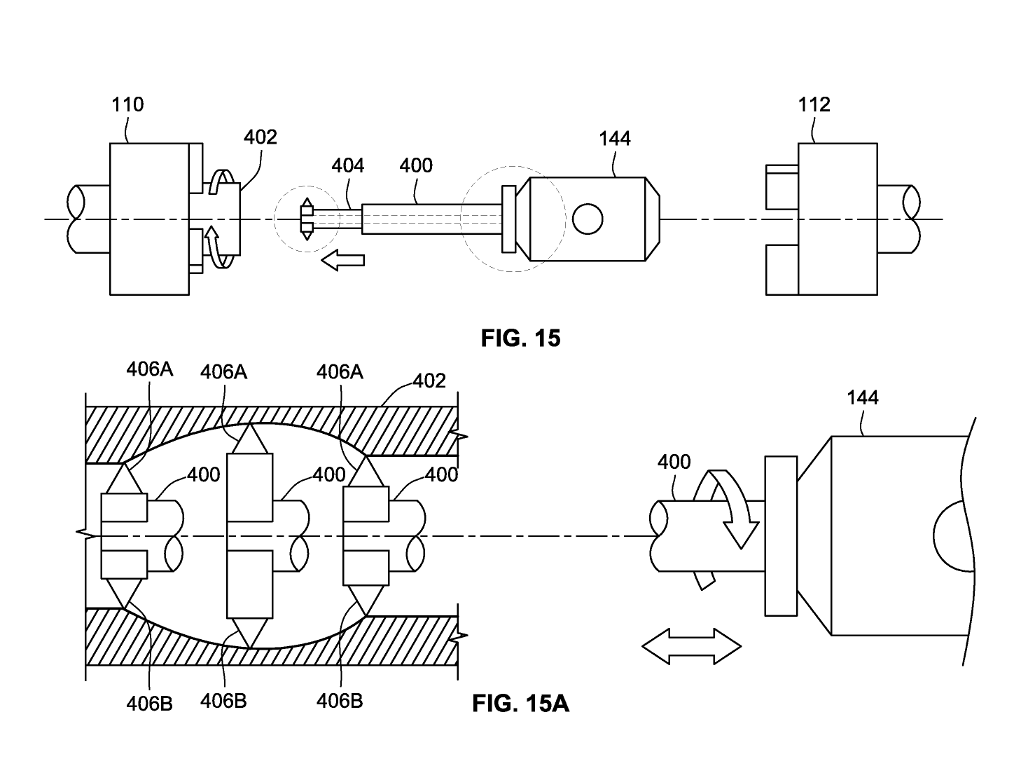

As the first chuck 110 rotates the workpiece 402, the b-axis spindle 144 moves the adjustable boring tool 400 into and out of the workpiece 402 (both rotation of the workpiece and movement of the adjustable tool 400 being illustrated in FIG. 15). A motive force generated by the b-axis spindle 144, namely servo motor 192, is transferred through the boring tool 400 to a pair of repositionable cutting inserts 406A and 406B. This motive force operates to selectively transversely reposition the cutting inserts 406A, 406B with respect to the tool housing 404. In particular, the servo motor 192 moves (e.g., translates or rotates) an internally mounted control arm 410, which may be in the form of the ball screw assemblies 210, 310 discussed above with respect to FIGS. 10-12.

FIG. 15A demonstrates that rotating the control arm 410 via the spindle 144 drives the cutting surfaces of the inserts 406A, 406B in and out of the tool housing 404. By way of explanation, and not limitation, the spindle 144 transitions a working end of the adjustable boring tool 400 in a first direction along a generally linear path into the internal cavity of the workpiece 402, such that the cutting inserts 406A, 406B are positioned at a first location within the cavity (e.g., at a distal or left-most location in FIG. 15A). This may occur prior to or contemporaneously with the spinning of the workpiece 402 via the first chuck 110 or, alternatively, prior to or contemporaneously the spinning of the adjustable tool 400 (e.g., in embodiments where the workpiece 402 is held stationary while the tool 402 is rotated for machining purposes). If not already in contact, the cutting inserts 406A, 406B are then engaged with the inner diameter of the workpiece 402. This may be accomplished, according to some exemplary configurations, by urging an internal control arm (e.g., a ball nut or draw bar) and, thus, a wedge in a first direction (e.g., leftward with respect to FIGS. 15 and 15A) to thereby project the cutting inserts 406A, 406B out of the housing 404 and into contact with the workpiece 402. The spindle 144 then transitions the working end of the adjustable boring tool 400 in a second direction opposite the first direction (e.g., rightward with respect to FIGS. 15 and 15A) such that the cutting inserts 406A, 406B are moved from the first location, through a second location (e.g., the middle position illustrated in FIG. 15A), to a third location (e.g., a proximal or right-most location in FIG. 15A). All the while, the cutting inserts 406A, 406B are selectively repositioned (e.g., projected out of and retracted into the housing 404) through manipulation of the internal control arm, as described above and/or below, to generate any “desired” machined profile, as seen in FIG. 15A. If so desired, the spindle 144 may then be operated to withdraw the adjustable boring tool 400 from the workpiece.

The servo motor 192 allows the CNC machine 100 to precisely control the movement of the cutting inserts 406A, 406B. Conventional milling motors are designed to rotate at a constant speed (RPM), and generally cannot be modulated to achieve a specific desired position. Modern servo motors, in contrast, have high resolution encoders and specialized software that allow for precise control of rotational speed, acceleration, deceleration, and/or position. In a servo motor, for example, angular velocity can be specified in terms of degrees or radians per minute as opposed to only revolutions per minute. Consequently, utilization of a servo motor, as exemplified by servo motor 192, to operate an adjustable boring tool allows for the precise manipulation of the tool's cutting inserts, which in turn permits the CNC machine to generate an almost infinite number of “desired” machined profiles. In this particular example, the sub-spindle 112 does not engage with the adjustable cutting tool 400. This option works well with a 6600 NT-Series machine, which is manufactured by Mori Seiki USA, Inc.

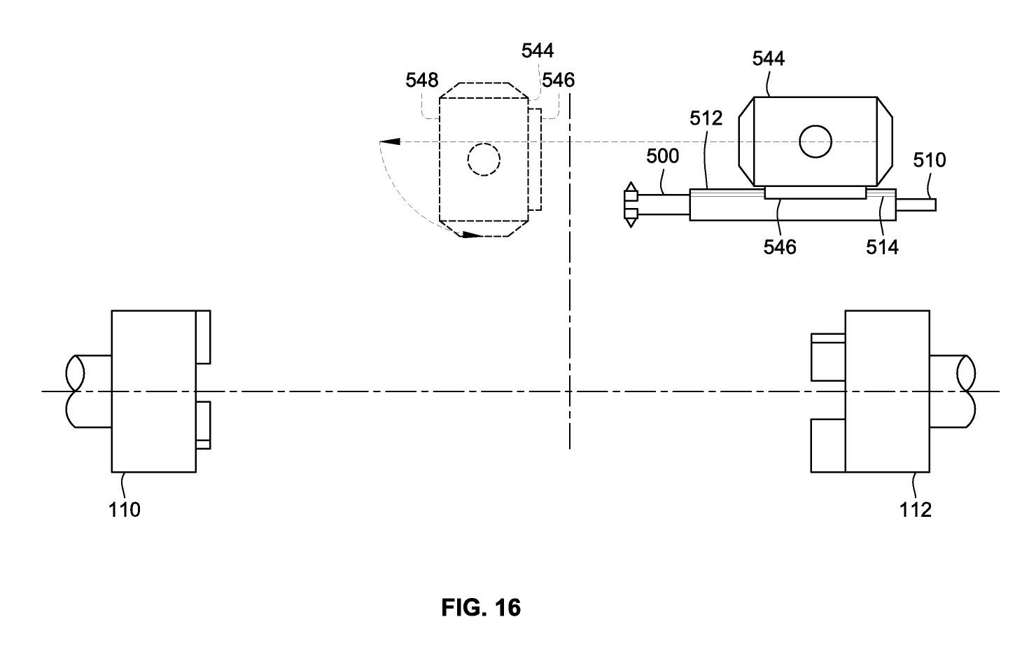

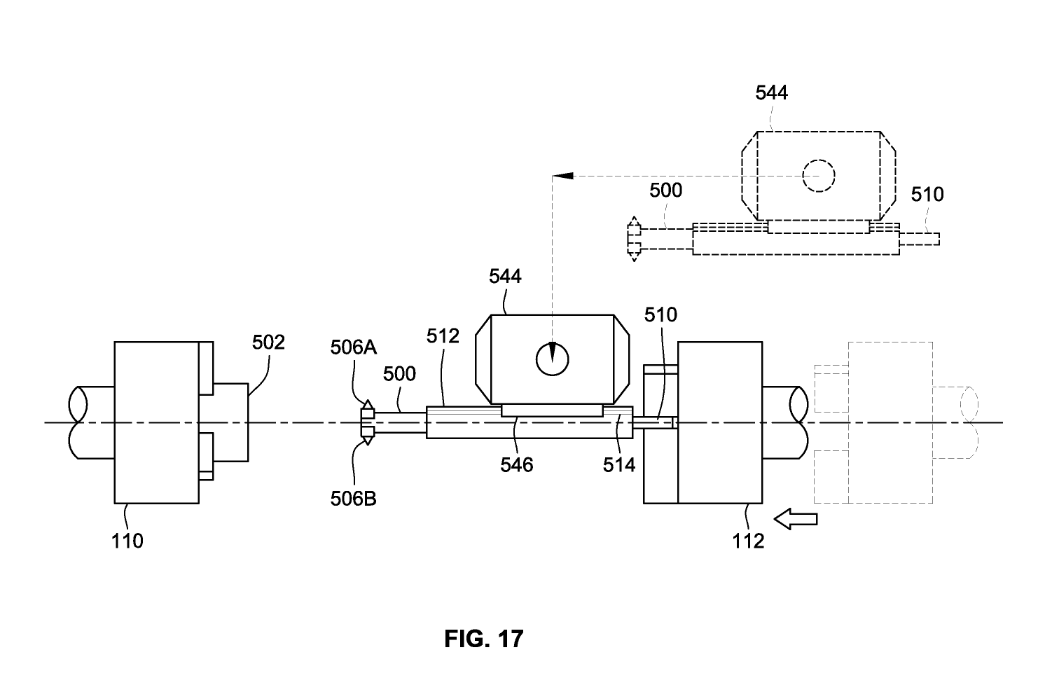

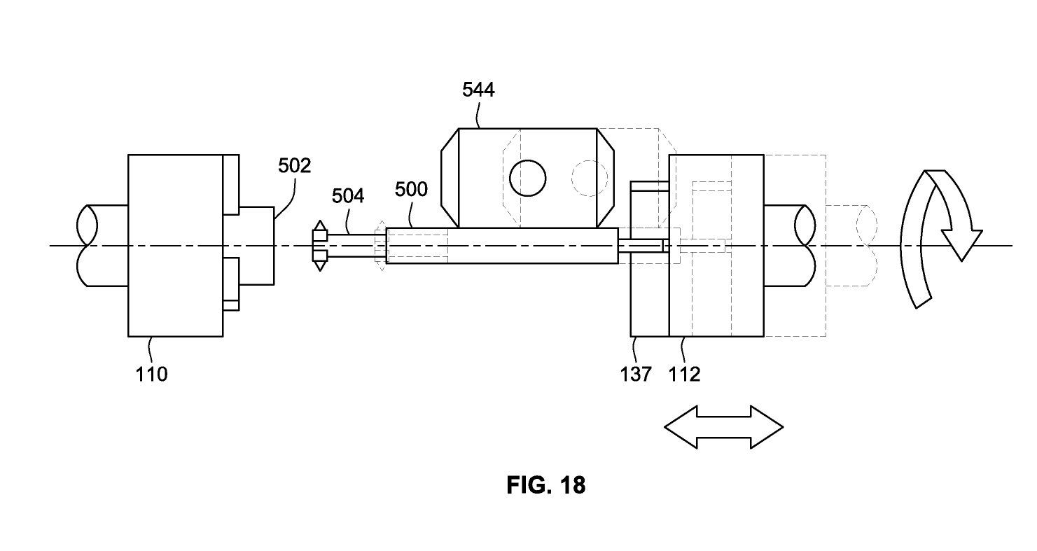

FIGS. 16-18 schematically illustrate the actuation and operation of another exemplary adjustable boring tool 500 via a movably mounted sub-spindle—e.g., second chuck 112 of the CNC machine 100. In contrast to the previously described embodiment, the adjustable boring bar 500 of this arrangement is mounted on the side of a tool spindle, e.g., “b-axis” spindle 544 of the CNC machine 100. The adjustable boring bar 500 is actuated by transverse pulling and pushing forces or rotational forces applied via the chuck 112. With the exception of the structural differences indicated below, the spindle 544 can be similar in design, function and operation to the spindle 144 of FIGS. 2-7. In a similar regard, the adjustable boring bar 500 can take on the same general configuration as the adjustable tools 200 and 300 presented above.

The b-axis spindle 544 includes an elongated side rail 546, which may be a dove-tail or T-shaped rail, for example, that extends longitudinally along an outer surface of the spindle housing 548. A bar rack 512 extends longitudinally along an outer surface of the housing 504 of the adjustable tool 500. The bar rack 512 includes a slot 514, which may be an elongated dove-tail or T-shaped channel, for example, for receiving the side rail 546 of the spindle 544. Alternative means for attaching the adjustable tool 500 to the spindle 544 is also envisioned, such as a peripherally mounted clamping device or latch mechanism. As seen in FIG. 16, the b-axis spindle 544 is repositioned, for example, via carriage assembly 120 and ram 132 of FIG. 3, from a first location and orientation (illustrated at 544 with hidden lines in FIG. 16) to a second location and orientation (illustrated at 544 with solid lines in FIG. 16). In accordance with the illustrated embodiment, the adjustable tool 500 is attached to the spindle 544 by passing the rail 546 into the slot 514. The spindle 544 then transitions from the second location to a third location (illustrated at 544 with solid lines in FIG. 16) to thereby reposition and operatively align the tool 400 with a main spindle, such as first chuck 110 of the CNC machine 100.

The adjustable tool 500 includes a control arm, which is presented in FIG. 16 as a rotationally stationary draw bar 510 that is operable to transmit a rectilinear force generated by the sub-spindle 112 to a pair of repositionable cutting inserts 506A and 506B. Alternatively, the control arm 510 of FIGS. 16-18 may be in the form of a ball screw assembly, such as assemblies 210, 310 discussed above with respect to FIGS. 10-12, that is operable to convert rotational forces generated by sub-spindle 112 into linear forces. As the first chuck 110 rotates the workpiece 502, the b-axis spindle 544 moves the adjustable boring tool 400 into the workpiece 502. A motive force generated by the sub-spindle 112 is transferred via control arm 510 through the boring tool 500 to the cutting inserts 506A, 506B. This motive force operates to selectively transversely reposition the cutting inserts 506A, 506B with respect to the tool housing 504. In the illustrated example, the control arm 510 is received within the movable jaws 137 and locked to the sub-spindle 112. The sub-spindle 112, in turn, shifts horizontally back forth, pushing and pulling on the draw bar 510. The rectilinear movement of the draw bar 510, as effectuated by the sub-spindle, 112 can act on an internally mounted wedge, such as wedge 208 of FIGS. 11 and 12 or wedge 308 of FIG. 13, which functions to retract and project the cutting inserts 506A, 506B from the housing 504. Alternatively, a rotational force generated by the sub-spindle 112 can be transmitted via the control arm 510 (e.g., when configured as a mechanical linear actuator that is operable to convert rotational forces into linear forces) to selectively reposition the cutting inserts 506A, 506B. These options works well with a 1000, 2000, 4200, 4300, 5400 NT-Series machine, which is manufactured by Mori Seiki USA, Inc.

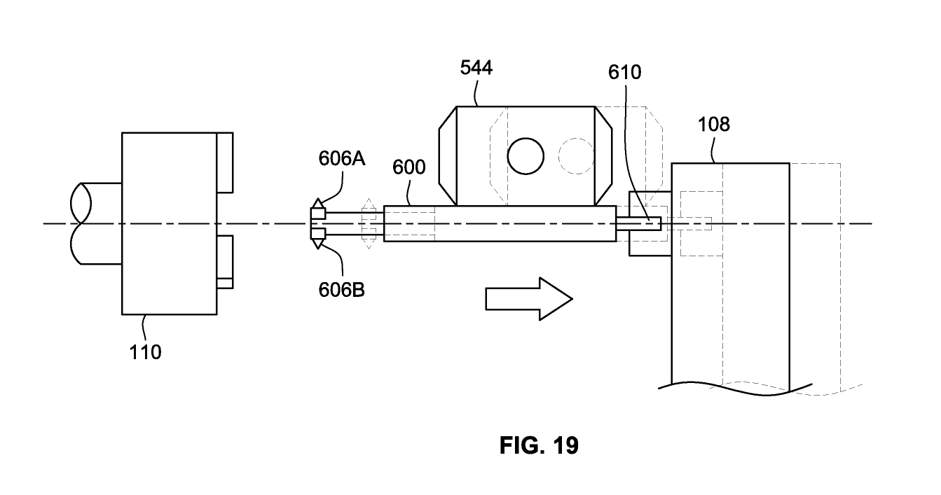

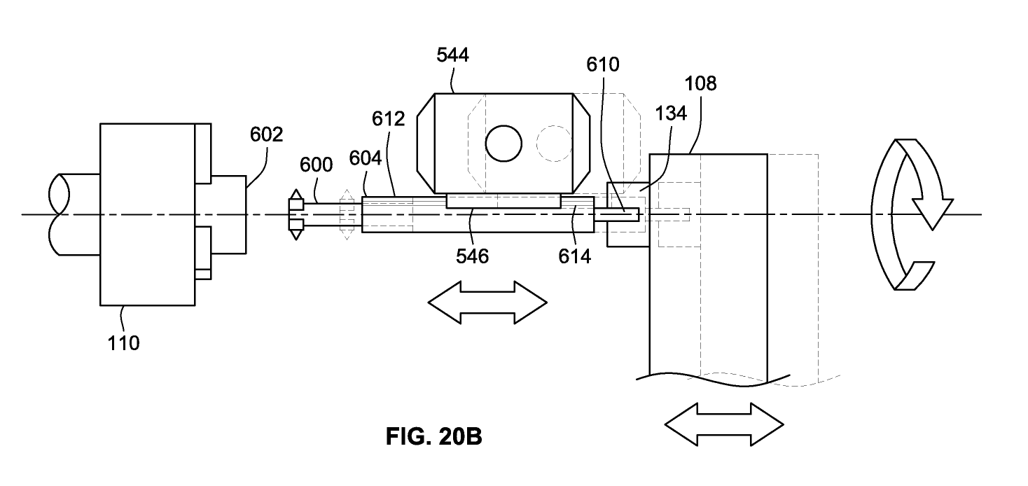

Turning next to FIGS. 19 and 20, the actuation and operation of an exemplary adjustable boring tool 600 via a movably mounted tool turret—e.g., turret 108 of the CNC machine 100, is sequentially illustrated in accordance with aspects of the present disclosure. In the arrangement illustrated in FIGS. 19 and 20, the adjustable boring bar 600 is mounted on the side of a tool spindle, e.g., “b-axis” spindle 144 of the CNC machine 100, and actuated by transverse pulling and pushing forces or rotational forces applied via the tool turret 108. The adjustable boring bar 600 can take on the same general configuration as the adjustable tools 200 and 300 presented above in FIGS. 10-12 or the adjustable tool 500 of FIGS. 16-18, without departing from the intended scope and spirit of the present disclosure. For instance, the adjustable boring tool 600 may include a longitudinally oriented bar rack 612 that extends along an outer surface of the housing 604 of the adjustable tool 600. The bar rack 612 includes a slot 614 for receiving the side rail 546 of the spindle 544.

The adjustable tool 600 includes a control arm, which is presented in FIGS. 19 and 20 as a rotationally stationary draw bar 610 that is operable to transmit a rectilinear force generated by the turret 108 to a pair of repositionable cutting inserts 606A and 606B. Alternatively, the control arm 610 may be in the form of a ball screw assembly, such as assemblies 210, 310 discussed above with respect to FIGS. 10-12, that is operable to convert rotational forces generated by turret 108 into linear forces. As the first chuck 110 rotates the workpiece 602, the b-axis spindle 544 moves the adjustable boring tool 600 into the workpiece 602. The control arm 610 of the adjustable tool 600 is received by and locked to one of the turret connectors 134 or a tool that is mounted to one of the turret connectors 134. A motive force generated by the turret 108—i.e., the turret connectors 134, is transferred via control arm 610 through the boring tool 600 to the cutting inserts 606A, 606B. This motive force operates to selectively transversely reposition the cutting inserts 606A, 606B with respect to the tool housing 604.

The aforementioned methods of actuating and controlling an adjustable boring tool are presented merely as an exemplification of the novel and improved disclosed concepts. For instance, although presented with reference to various adjustable boring tools, the disclosed concepts can be applied to other adjustable machining tools, such as lathe tools, broaching tools, grinding tools, etc. To this end, the disclosed concepts are not limited to the CNC machine 100 illustrated above, which is presented solely for explanatory purposes. The various methods of actuation disclosed above could also be used on other machines, such as, for example, an NL machine with a special expanding/adjustable tool located on a turret and actuated by a tailstock (e.g., a spherical seat on a differential case), or an NL machine with a special expanding/adjustable tool located on a turret and actuated by a second turret.

Also disclosed herein are improved methods of operating an adjustable tool, such as adjustable tool 200 of FIGS. 10 and 11 or adjustable tool 300 of FIG. 12, with a material-working machine that has one or more prime movers, such as CNC machine 100 of FIGS. 1-9. The adjustable tool has at least one cutting insert (e.g., inserts 206A, 206B of FIG. 11) that is selectively transversely repositionable with respect to the tool housing (e.g., housing 204). A wedge, such as wedges 208 and 308, mates with the one or more cutting inserts, and is configured such that movement of the wedge effectuates transverse movement of the one or more cutting inserts. A control arm, such as control arms 210 and 310, is movably mounted to the housing and attached to the wedge. The method includes, in some embodiments, attaching the adjustable tool to the CNC machine, mechanically coupling the wedge to the prime mover via the control arm, engaging the cutting insert(s) with a workpiece, and transversely repositioning the cutting insert(s) via the control arm and the wedge through operation of the prime mover, which may be accomplished in any of the manners disclosed herein.

In accord with aspects of the present disclosure, attaching the adjustable tool to the CNC machine can include capturing the adjustable tool with a spindle that is movably mounted to the CNC machine, such as b-axis spindle 144 of FIGS. 2 and 3. In this instance, the prime mover may include a servo motor that is integral with (e.g., housed inside) the b-axis spindle. Mechanically coupling the wedge may therefore include operatively mating the control arm of the tool with the servo motor inside the spindle. To that end, rotational forces generated by the servo motor are received by the control arm and converted thereby to translational forces. These forces are transmitted by the control arm to the wedge to effectuate linear movement thereof. In so doing, the cutting inserts are retracted into and/or projected out of the tool housing.

In an alternate arrangement, the b-axis spindle or the adjustable tool includes an elongated rail, whereas the other of the two components includes a complementary slot configured to receive therein the elongated rail. For example, the spindle may include a dove-tail or T-shaped rail that extends longitudinally along an outer surface of the spindle. A bar rack extends longitudinally along an outer surface of the housing of the adjustable tool. The bar rack includes an elongated dove-tail or T-shaped slot for receiving the dove-tail/T-shaped rail of the spindle. The adjustable tool is attached to the CNC machine by passing the rail into the slot thereby attaching the adjustable tool to the b-axis spindle.

According to other aspects of the present disclosure, the prime mover is a sub-spindle, such as chuck 112 of FIGS. 2 and 3, which is movably mounted to the CNC machine. In this instance, the wedge is mechanically coupled to the CNC machine by operatively mating the control arm with the sub-spindle. For instance, a proximal end of the control arm can be captured by the movable jaws 137 of the second chuck 112. By using the second chuck 112 as the prime mover, the cutting inserts can be repositioned by either rotating the control arm via the sub-spindle or rectilinearly translating the control arm via the sub-spindle, or both, depending upon the design of the adjustable tool.

In other aspects of the present disclosure, the prime mover is a tool turret that is movably mounted to the CNC machine, such as tool turret 108 of FIGS. 3 and 5. The wedge can be mechanically coupled to the CNC machine by operatively mating the control arm of the adjustable tool, for example, with one of the various turret connectors (or “facets”) 134 of the tool turret. By using the tool turret, the cutting insert(s) can be retracted into and/or projected out of the tool housing by rotating the control arm via a motor retained by the tool turret or rectilinearly translating the control arm via linear translation of the tool turret, or both

### Alternate Embodiments

Presented hereinbelow are an array of alternative embodiments and variations that fall within the scope and spirit of the present disclosure. The variants discussed hereinafter are not intended to represent every embodiment, or every aspect, of the present disclosure, and should therefore not be construed as universal limitations. Further, the following variants and embodiments may be used in any combination or subcombination not logically prohibited.

A method and a mechanism for actuating an adjustable tool, whether rotating or non-rotating, includes: applying a rotational motion through a tool spindle or a tail stock, wherein the insert position can be incrementally adjusted by imparting rotational motion; the tool, mounted on the face of the tool spindle and tailstock, is actuated by using a servo-controlled motor; and removing material.

An apparatus for actuating an adjustable tool, whether rotating or non-rotating, may also include tool changing capabilities.

A method of actuating a rotating tool mounted on the tool spindle may be by means of push-pull contact between the tool spindle and the tool mounted on the turret.

A method and a mechanism for actuating an adjustable tool, whether rotating or non-rotating, may be by applying a rotational motion, wherein the insert position can be incrementally adjusted by imparting rotational motion resulting in material removal, and wherein the adjustable tool is mounted on the adjacent face of the tool spindle.

An apparatus for actuating an adjustable tool, whether rotating or non-rotating, may include a slide mechanism along with a locking mechanism to mount and clamp the adjustable tool onto the adjacent face of the tool spindle.

An apparatus for actuating an adjustable tool, whether rotating or non-rotating, actuates the adjustable tool by applying a rotational motion through the tool turret, a turret tool, or by using a main/sub-spindle, wherein the insert position can be incrementally adjusted for every single rotation of the turret, turret tool, or main/sub-spindle.

An apparatus for actuating an adjustable tool, whether rotating or non-rotating, actuates the adjustable tool by applying a linear force via a sub-spindle, a turret tool, or the tool turret—e.g., by moving the tool turret or by displacing the tool turret using piezoelectric or magnetostrictive actuators, wherein the insert position can be incrementally adjusted for every single increment motion of the turret or sub-spindle.

A method of achieving variable tool path for an adjustable tool located on a spindle includes simultaneous rotational motion of turret tool for actuation purposes and traverse turret or tool-spindle motion for achieving various traverse cutting motions.

A method of achieving adjustable tool path for an adjustable non-rotating tool located on the spindle includes simultaneous rotational motion of sub-spindle for actuation purpose and traverse sub-spindle motion as well as tool spindle motion for achieving various traverse cutting motions.

An apparatus for actuating an adjustable tool, whether rotating or non-rotating, wherein the tool is rotated and driven by the sub-spindle or by a tool turret.

A method and a mechanism for actuating an adjustable tool, whether rotating or non-rotating, located on a turret/tool post includes: applying a lateral transverse force or rotational force via other controllable axis such as tailstock, sub-spindle, turret, or additional turret tools, wherein the tool position can be incrementally adjusted for every single transverse or rotational incremental motion of the other controllable axis.

A method of achieving an adjustable tool path for an adjustable tool located on the turret/tool post includes simultaneous incremental motion of the tool along with incremental motion of actuating axis such as tailstock, sub-spindle, turret, or additional turret tools.

A method or apparatus of achieving an adjustable tool path for an adjustable tool via a tool mounted on a turret, wherein the tool mounted on the turret can be actuated by other mechanical means, such as via hydraulic or pneumatic means.

An apparatus for actuating an adjustable tool, whether rotating or non-rotating, actuates the tool by a push-pull motion of the turret in X- and/or Z-directions.

A method for tool wear compensation based on the options and features described hitherto.

A method for machining features concentric or non-concentric with respect to the axis of the workpiece center, based on the options and features described hitherto.

Based on the options and features described hitherto, an adjustable tool to machine and gauge the internal diameter of the machined bores in one setup using high pressure coolant.

An adjustable tool for simultaneous machining and gauging of internal diameters on the workpiece using high pressure coolant. The adjustable tool can include coolant orifices and gauge orifices (e.g., incorporated into the inserts themselves or on other segments of the adjustable tool) that are configured to project and/or retract the cutting inserts through the modulation of hydraulic fluids, such as high pressure coolant.

A process wherein an adjustable tool machines the internal diameter of workpiece bores during the “in feed” motion, and gauges those internal diameters, using high pressure coolant, during the “out feed” motion.

A hydraulic circuit selectively provides coolant to the adjustable tool insert during machining and coolant to the gauge for measurement purposes.

While particular embodiments and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of the disclosure as defined in the appended claims.

What is claimed is:

1. A material-working machine operable to remove material from a workpiece, the material-working machine comprising:
at least one prime mover;
an elongated housing;
at least one cutting insert at least partially disposed in the housing, the at least one cutting insert being selectively transversely repositionable with respect to the housing;
a wedge selectively longitudinally repositionable with respect to the housing, the wedge mating with the at least one cutting insert and configured such that longitudinal movement of the wedge effectuates transverse movement of the at least one cutting insert; and
a control arm movably mounted to the housing, the control arm being connected to the wedge and configured to mechanically couple the wedge to the at least one prime mover of the material-working machine such that motive force is transferred from the at least one prime mover through the control arm to the wedge for the selective repositioning thereof.

2. The adjustable tool of claim 1, wherein the control arm includes a ball screw operable to convert a rotational force generated by the at least one prime mover into a linear force, the ball screw being configured to transmit the linear force to the wedge to thereby selectively reposition the wedge.

3. The adjustable tool of claim 2, wherein the ball screw includes a ball nut receiving therethrough a threaded shaft, the threaded shaft being rigidly connected to the wedge, and the ball nut operatively connecting the threaded shaft to the housing.

4. The adjustable tool of claim 2, further comprising at least one bushing disposed between the housing and the ball screw, the at least one bushing providing lateral support for the ball screw.

5. The adjustable tool of claim 1, wherein the control arm includes a draw bar operable to transmit a rectilinear force generated by the at least one prime mover to the wedge to thereby selectively reposition the wedge.

6. The adjustable tool of claim 1, wherein one of the wedge and the at least one cutting insert includes an angled slot, and the other of the wedge and the at least one cutting insert includes a protrusion projecting therefrom into the angled slot, and wherein the angled slot applies an inward force to the protrusion when the wedge transitions in a first direction, and applies an outward force to the protrusion when the wedge transitions in a second direction opposite the first direction.

7. The adjustable tool of claim 1, wherein the wedge is received within a complementary guide slot defined by the housing, the guide slot restricting transverse and rotational movement of the wedge.

8. The adjustable tool of claim 1, wherein the prime mover includes a servo motor integral with a spindle movably mounted to the material-working machine.

9. The adjustable tool of claim 8, wherein one of the movable spindle and the adjustable tool includes an elongated rail, and the other one of the movable spindle and the adjustable tool includes a complementary slot, the slot being configured to receive therein the rail and thereby attach the adjustable tool to the movable spindle.

10. The adjustable tool of claim 1, wherein the prime mover includes a sub-spindle movably mounted to the material-working machine.

11. The adjustable tool of claim 1, wherein the prime mover includes a tool turret movably mounted to the material-working machine.

12. A computer numerically controlled (CNC) machine comprising:
a workpiece holder;
a repositionable spindle;
a prime mover; and
an adjustable tool operable for removing material from a workpiece, the adjustable tool including:
an elongated housing;
one or more cutting inserts at least partially disposed in the housing, each of the one or more cutting inserts being selectively radially repositionable with respect to the housing;
a wedge selectively longitudinally repositionable within the housing, the wedge mating with the one or more cutting inserts and configured such that longitudinal movement of the wedge effectuates radial movement of the one or more cutting inserts; and
a control arm movably mounted inside the housing, the control arm being connected to the wedge and configured to mechanically couple the wedge to the prime mover such that motive force generated by the prime mover is transferred by the control arm to the wedge for the selective repositioning thereof.

13. A method of operating an adjustable tool with a computer numerically controlled (CNC) machine having at least one prime mover, the method comprising:
attaching the adjustable tool to the CNC machine, the adjustable tool having at least one cutting insert selectively transversely repositionable with respect to a housing, a wedge mating with the at least one cutting insert and configured such that movement of the wedge effectuates transverse movement of the at least one cutting insert, and a control arm movably mounted to the housing and attached to the wedge;
mechanically coupling the wedge to the at least one prime mover via the control arm;
engaging the at least one cutting insert with a workpiece; and
transversely repositioning the at least one cutting insert via the control arm and the wedge through operation of the at least one prime mover.

14. The method of claim 13, wherein the attaching the adjustable tool to the CNC machine includes capturing the adjustable tool with a spindle movably mounted to the CNC machine.

15. The method of claim 14, wherein the at least one prime mover includes a servo motor integral with the spindle, and wherein the mechanically coupling the wedge includes operatively mating the control arm with the servo motor.

16. The method of claim 14, wherein one of the spindle and the adjustable tool includes an elongated rail, and the other one of the spindle and the adjustable tool includes a complementary slot, and wherein the attaching the adjustable tool to the CNC machine includes passing the rail into the slot thereby attaching the adjustable tool to the spindle.

17. The method of claim 13, wherein the prime mover includes a sub-spindle movably mounted to the CNC machine, and wherein the mechanically coupling the wedge includes operatively mating the control arm with the sub-spindle.

18. The method of claim 17, wherein the transversely repositioning the at least one cutting insert includes rotating the control arm via the sub-spindle or rectilinearly translating the control arm via the sub-spindle, or both.

19. The method of claim 13, wherein the prime mover includes a tool turret movably mounted to the CNC machine, and wherein the mechanically coupling the wedge includes operatively mating the control arm with the tool turret.

20. The method of claim 19, wherein the transversely repositioning the at least one cutting insert includes rotating the control arm via a motor retained by the tool turret or rectilinearly translating the control arm via the tool turret, or both.
